(19) United States
(12) Patent Application Publication
(10) Pub. No.: US 2009/0063316 A1
(43) Pub. Date: Mar. 5, 2009

(54) SYSTEM AND METHOD FOR EXCHANGING FOREIGN COINS AND CURRENCY

(76) Inventors: RICHARD C. TRAVIS, SEMINOLE, FL (US); JAESON BANG, SAFETY HARBOR, FL (US)

Correspondence Address: DANIEL S. POLLEY, P.A., 1215 EAST BROWARD BOULEVARD, FORT LAUDERDALE, FL, 33301, US

(21) Appl. No.: 11/847,960

(22) Filed: Aug. 30, 2007

(51) Int. Cl. G06Q 40/00

(52) U.S. Cl. 705/35

(57) ABSTRACT

A system and method are disclosed for converting leftover foreign currency into the native funds of a foreign traveler. The system is preferably embodied similar to haw an ATM and Vending machines mechanically operate and is preferably located at a final destination for a foreign traveler such as an airport. The machine can preferably accept both coins and paper currency. Rather than converting the foreign money into the native currency, the traveler can insert a financial card and the converted currency is credited to the account associated with the card. Alternatively, a gift card can be credited and issued to the traveler for the amount of the converted currency. The system can be designed to receive accurate exchange rates once the traveler's desired country is selected. The system can also deduct a transaction fee before crediting the converted amount to the traveler.

### FIELD OF THE INVENTION

The present invention relates generally to currency exchange systems and particularly to a foreign coin and currency exchange system and method based on the physical location of the system.

Background of the Invention

When traveling out of one's home country, most often the foreign traveler exchanges his or her home country currency for currency (i.e. paper and coin money) of the country he or she is traveling to. Frequently, all of the foreign country currency is not entirely used by the end of the trip. As a non-limiting example, using the United States as the country visited, it is not uncommon for the traveler to have at least $20.00 to S50.00 worth of foreign currency (USD) at the end of the trip. Often, the traveler merely returns home with the foreign money, especially, where the amount of money left over is not worth the time and effort to exchange for the traveler's home country currency. Thus, a large amount of travelers reluctantly keep the foreign money with them as a souvenir or give it away as gift. The present invention provides a relatively quick and easy self-operating system and method for exchanging foreign coins and currency to plurality of funds, which also is preferably located in convenient and/or or easy to find locations.

### SUMMARY OF THE INVENTION

The present invention provides a system and method for converting leftover foreign currency into the native funds of the traveler. In one embodiment, the invention is embodied as a stand alone or wall embedded machine (i.e. which can be similar to how an ATM machine mechanically performs its task and how a Vending Machine receives and counts money, and can be similar in appearance to these machines) preferably located at a final foreign destination for a foreign traveler (i.e. departing airport, train station, cruise ship port, hotel, etc.). The device preferably accepts both coins and paper currency. In a preferred embodiment, rather than converting the foreign money into the currency of the traveler's choosing, the traveler inserts his or her credit or debit card and the converted currency is credited to the traveler's card or bank account. Additionally or alternatively, a gift card can be credited and issued to the traveler for the amount of the converted currency. Non-limiting examples of the gift card include, but are not limited to, store cards, shopping mall cards, gas cards, etc.

As the system is preferably used for converting foreign currency, the system includes means for receiving accurate exchange rates. In the preferred embodiment, the system is provided with online, Internet access or other electronic access to download or receive the relevant exchange rate information. Preferably, a fee will be charged for use of the system and can be preferably deducted from the amount of currency deposited, prior to conversion and/or prior to crediting the selected card (i.e. credit card, gift card, debit card, etc.). The converted funds can also be provided in the form of voucher to be redeemed or turned in at another location.

The system preferably comprises a display where the user can be informed of one or more of the following, the amount of currency he or she deposited, the current exchange rate, the amount of currency being deducted as a transaction fee, the total amount credited to the user, etc. A receipt for transaction can also be provided to the user by the system.

Certain features of the present invention system/machine can perform similar to vending machine technology in its ability to calculate money, ability to transact money, ability to sort out cash, can be provided with a safe or other secured or theft prevention box or receptacle for safely storing coins and paper money inserted into the machine, and its ability to reject invalid coin or paper insertions. As such, conventional vending machine technology is incorporated by reference. Other features of the present invention system/machine can also perform similar to ATM machine technology in its ability to process inserted cards, communicate with accounts, ability to transact money, ability to allow a user to select a language for instructions, and its ability to provide a printed receipt of the transaction. As such, conventional ATM machine technology is also incorporated by reference.

The machine can have a screen, such as but not limited to, a LCD screen on top, with blinking lights (i.e. red blinking light, similar to that of traditional currency exchange booth etc.) which can display the currency exchange rate on top of the machine. The displayed rate can be once the user identifies the specific country, or can be a rotating/changing display which displays a country's rate for a period of time (i.e. 10 seconds, etc.) before switching to a next country's rate. In this version, interest for the machine from patrons of the location may be generated. Other indicia, text, images, symbols can also be displayed by the display, provided on the touch screen and/or provided on the machine itself.

The present invention machine accepts money and dispenses cards, vouchers, and other non-money forms. The machine can have multiple capabilities, such as but not limited to (1) US dollars to funds of a customer's choice; and (2) foreign currency to US dollars. The machines are preferably strategically positioned to serve the customer demographics, such as, but not limited to (a) at or near US carriers terminal; (b) at or near European Carriers terminal (USE) to Euro); (c) at or near Japanese Carriers terminal (USD to Yen); (d) at or near Australian Carriers terminal (USD to Australian Dollar); and (e) at or near Mexican Carriers terminal (USD to Peso). These locations are merely non-limiting examples and various other locations (airports and non-airport locations) can be selected and all are considered within the scope of the invention. Also the machine can accept one type of currency and convert such currency into a plurality of funds. Furthermore, the machine can be strategically positioned, but it should not be considered limited to the nationality of the carrier. As a non-limiting example using the US market, the machine can accept USD and can have the capability to convert it to plurality of funds of the customer's choosing. As another non-limiting example using the European market, the machine can accept Euros and convert it to a plurality of funds.

The screen display can show text, images, animations, video, symbols, country flags, etc. Audio instructions can also be provide and incorporated the present invention system/machine. Where audio is provided, the machine preferably is also provided with at least one speaker. Again what is displayed is not limited to any particular information and all are considered within the scope of the invention.

Other preferred features of the present invention machine can include, but are not limited to, (a) a bill or paper money receptacle; (b) money return bin, such as for invalid money; (c) multiple language capabilities; (d) credit or debit card slider and/or reader; (e) coin receptacle; (f) gift card, voucher or other Fund Dispenser; (g) ATM style and/or appearance; (h) touch screen panel; and (i) Internet, Intranet, online, and/or other electronic connection.

The form of usable funds that the foreign currency is converted is limitless, and can include, but is not limited to, the following: (a) gift card by various vendors of customer's choice; (b) gift card by a credit card company; (c) converted funds credited to a credit card account through a credit card; (d) converted funds credited to a bank account through a debit card; (e) converted funds donated to an associated charity of the system or to a user selected charity (the machine can provide a list of charities to the user for selection).

The type of gift cards is limitless, and can include, but is not limited to: airlines, hotels, I tune store or other music download service; Starbucks store or products, Nike store or products; phone company; book store such as Barnes and Noble, Amazon.com or Borders; converted to minutes for a cell phone account or a calling card; etc.

Accordingly, the present invention provides a relatively quick, convenient and efficient way of converting foreign currency to a form of usable funds of a traveler/user's home country.

### BRIEF DESCRIPTION OF THE DRAWINGS

FIG. 1 is a perspective view of a non-limiting example of the physical structure of the currency exchange machine in accordance with the present invention system and method;

FIG. 2 is an alternative embodiment for the non-limiting physical structure of the currency exchange machine in accordance with the present invention system and method;

FIG. 3 is a block diagram of the main components for the present invention system and system flow;

FIG. 4 is a detailed flowchart illustrating the steps performed by the present invention for one non-limiting example of use; and

FIG. 5 is a detailed flowchart illustrating the steps performed by the present invention for another non-limiting example of use.

### DETAILED DESCRIPTION OF THE PREFERRED EMBODIMENT

As seen in the Figures the present invention provides a system and method for exchanging a travelers foreign currency back into usable funds (preferably in the form of debit card, credit card, gift card, etc. as opposed to currency) in the traveler's home country. The system will be generally designated as reference numeral 20. System 20 can be provided in the form of a free standing or wall attached machine 30, which can be similar in appearance to a standard ATM machine, though such appearance is not considered limiting.

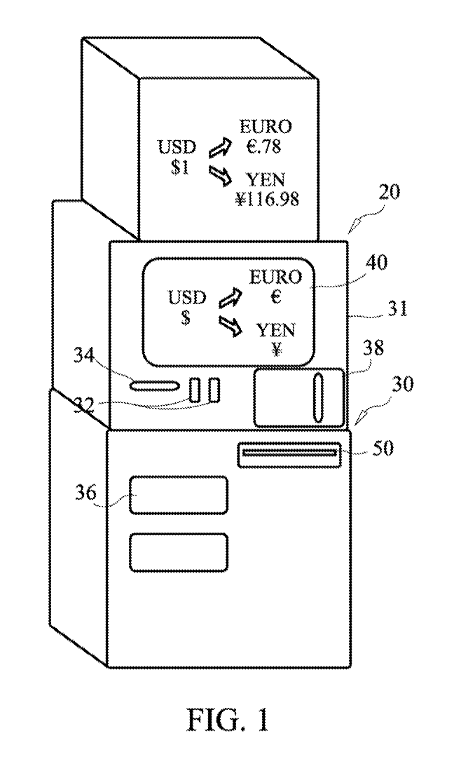

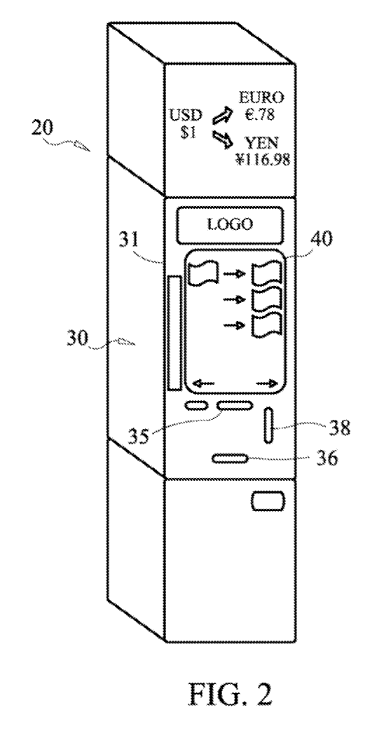

Machine 30 can be provided with a housing 31 having a coin receiving receptacle 32 and a paper money receiving receptacle 34 (FIG. 1) or a combination coin and paper money receptacle 35 (FIG. 2). For ease of discussion the term “currency receptacle” will be considered to encompass both versions (i.e. separate coin and paper receptacles or combination coin and paper receptacles). A gift card dispenser/receipt area or slot 36 can be provided where machine 30 dispenses a gift card and/or gift receipt as a payment option form for the traveler from the converted currency. A credit card slider/slot 38 can be provided where machine 30 permits crediting a debit card, bank card or credit card of the traveler with the amount of the converted currency (preferable minus any transaction charges). As seen in the Figures, many payment receipt options can be provided on a single machine 30, such that slots 36 and 38 can both be provided on machine 30. Conventional card reading technology can be associated slot 38 for reading the account information disposed on an inserted credit card, debit card, bank card, etc. (collectively referred to as “card”). Additionally, system 20 can be set up to be in communication with the foreign traveler's, bank account, gas card, credit card account, etc. such that upon insertion of a card into 38, the converted amount of funds, can be disposed into the traveler's bank account or applied to the credit card account associated with the inserted card. Any, conventional technology, currently used or later developed which provides communication between a remote card slider and a bank or credit card account can be used for system 20 and all are considered within the scope of the present invention.

A touch screen or display 40 can be provided for providing information for the user/traveler. Where a touch screen is provided areas on the touch screen display can be dedicated or designated for touch-screen navigation. Where display 40 is a non-interactive, button(s), keypad, keyboard, etc. can be provided for entering any relevant information, which can then be viewed by display 40. Machine 30 can also be provided with an internally disposed receipt printer for printing a physical receipt of the transaction, which will be provided through slot 50.

The invention is not considered limited to the display of any particular information on display 40. However, it is envisioned that as a non-limiting example, a user/traveler may want to have displayed one or more of the following: (1) the amount of currency inputted into machine through the currency receptacles, (2) the specific exchange rate between the country where the machine is disposed and the user's home or native country, (3) the amount of exchanged currency in the home country currency, (4) the amount of any transaction fees, the amount of home country currency being given to the user after any transaction fees have been deducted, (5) a choice of store(s) for the gift card (if a plurality of stores are associated with system 20), (6) the user's bank account or credit card account number, etc.

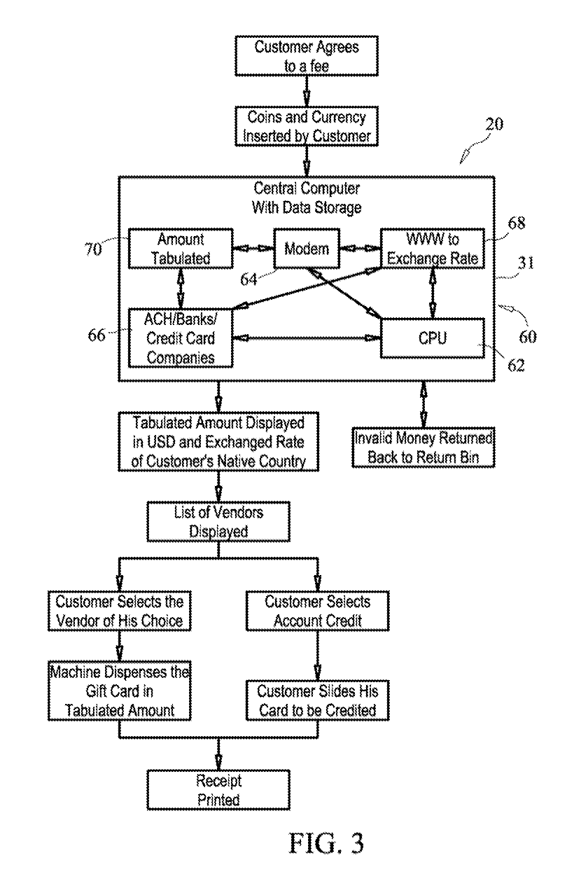

As seen in FIG. 2, the area for dispensing the gift card or the printed receipt can be the same location or as seen in FIG. 1, separate areas can be designated on machine 30 for the dispensing of a gift card and a receipt of the transaction. As best seen in FIG. 3, a central computer and data storage 60 is preferably contained within housing 31 and includes a central processing unit (“CPU”) component 62 which can be in communication with a modem 64, a financial account (banks, credit cards, ACH, etc.) interface 66 and an currency exchange rate interface or receiver 68. In addition to being in communication with CPU 62, financial account interface 66 can also be in communication with currency exchange rate receiver 68 and an amount tabulated counter 70. Currency exchange rate receiver 68 is also in communication with amount tabulated counter 70 and modem 64. Preferably receiver 68 receives current currency exchange rate information between the foreign country where machine 30 is physically located and the home country of the traveler/user of machine 30/system 20. The current currency exchanger rate information is preferably received electronically, such as, but not limited to over the World Wide Web, Internet, Satellite, Intranet, etc. As illustrated in FIG. 3, one non-limiting example of how the current currency exchange information is obtained by receiver 68 is by the World Wide Web through modem 64.

Amount tabulated counter 70 is in communication with the currency receptacles of machine 30 and is any conventional technology that counts and keeps a total of the amount of currency deposited or inserted into machine 30 by the traveler/user. Counter 70 can be in communication with display 40 and can be directed to display a running total of the amount of foreign currency deposit as each piece (coin or paper) is inserted or display a final total and receiving information (i.e. user selects a “total” button, etc.) that the user/traveler has finished depositing the foreign currency. CPU 62 can be a conventional CPU found in ATM and similar type of financial machines, programmed accordingly to accomplish the methods and advantages of the present invention system. CPU 62 preferably performs the necessary calculations (i.e. currency conversion, transaction fee deductions, etc.) of the present invention system and method and provides the different instructions to the various other components of system 20. A data storage medium, such as but not limited to computer memory, can also be provided and be in communication with CPU 62. CPU 62 can also control the information displayed on screen 40 and receive and act on the traveler's entered instructions such as, but not limited to, touch screen navigation on screen or display 40.

Various lists such a participating vendor lists (i.e. for gift cards,), list of home country choices, list of daily, monthly, etc. transactions performed by machine 30, etc. can be stored with the memory and accessed as needed. CPU 62 is also preferably in communication with the credit/debit card reader technology of the present invention system (which technology can be conventional) which can also be part of financial account interface 66. CPU 62 can also send instructions and/or otherwise control a gift card dispenser of system 20 (i.e. where gift cards are a choice for the usable form of home country money) and/or the receipt printer of system 20. Preferably, both the gift card dispenser and the receipt printer are conventional components and can be disposed within housing 31. The printed receipt, and credited gift card are dispensed through openings (i.e. slots, apertures, etc.) of housing 31 through conventional technology.

Housing 31 can be a self standing unit or embedded or secured to a wall. As mentioned above, housing 31 can be preferably located at a final destination in the foreign country (i.e. such as, but not limited to, an airport, hotel, train station, etc.) such that the user/traveler no longer needs the foreign currency for any purchases.

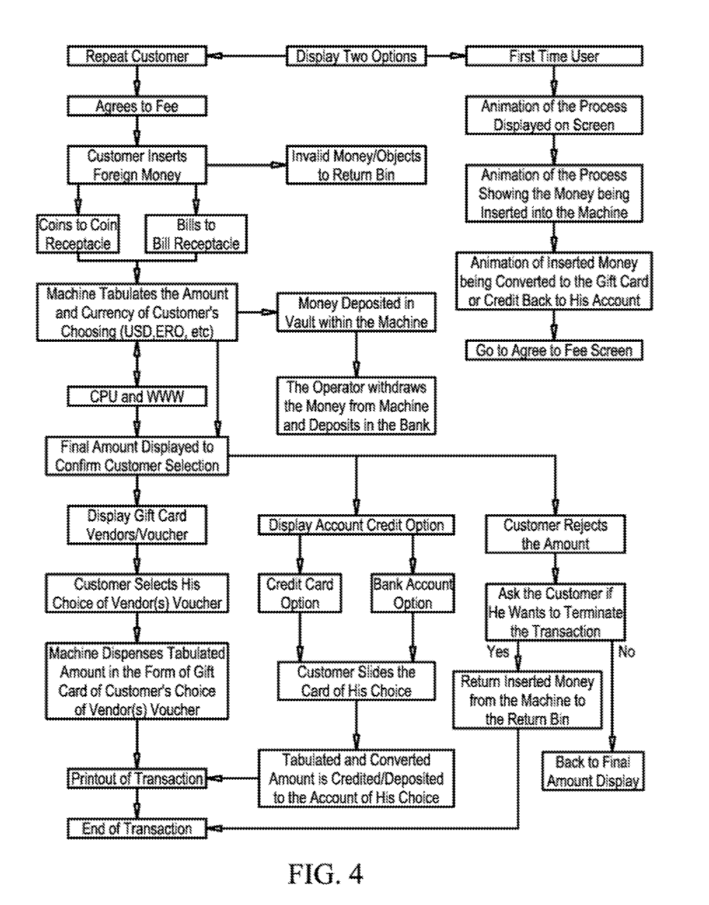

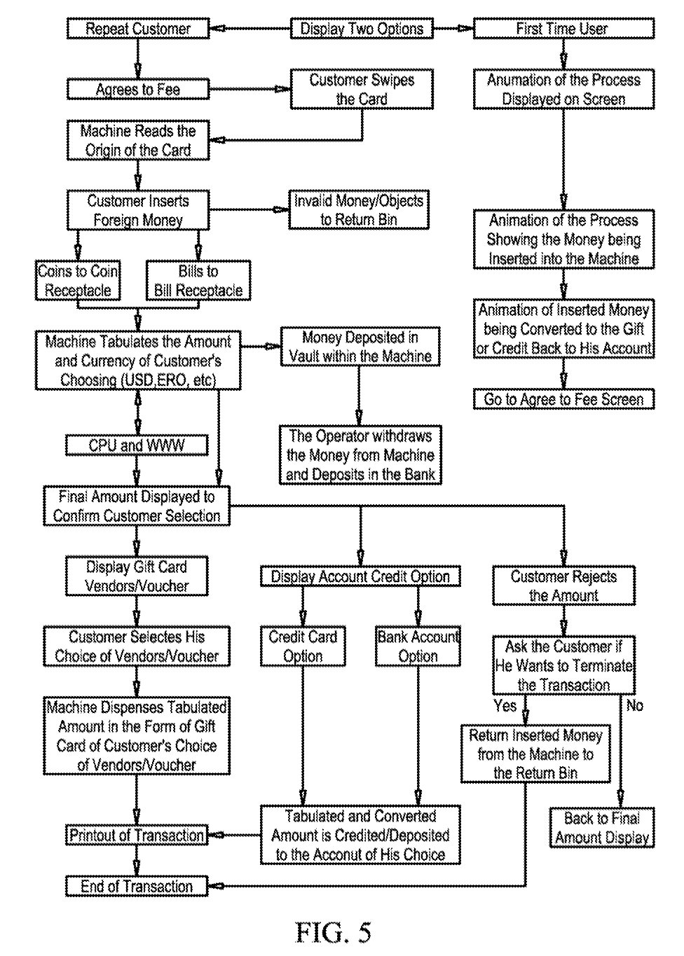

Below is a further explanation of the method performed by the system of the present invention. Two non-limiting detailed examples are illustrated in FIGS. 4 and 5. However as a general description of the method the below discussed non-limiting example will assume a non US traveler who is in the United States for whatever reason and who wishes to exchange or convert his remaining or leftover US currency into usable funds of his home country or any other country he selects (i.e. the traveler may not be going directly home and wishes to convert the US funds to usable funds for the next country he or she is traveling to, etc.). The traveler approaches machine 30 and is informed that a transaction fee (i.e. 8%, 10%, 12%, etc) will be deducted from the amount of currency deposited. It can also be set up that there is no transaction fee for converting to gift, card, though such is not considered limiting. Additionally, it can also be set up that there is no transaction fee for any form of usable funds created. However, where there is a transaction fee charged, the amount of the fee can be preferably posted at machine 30 or adjacent thereto so that the traveler knows prior to entering any United States currency how much he or she will be charged for the services performed by the present invention system and method. Additionally, if the transaction fee is displayed after money is charged or if the user changes his or her mind regarding converting the inserted currency, a mechanism can be provided on machine 30 for returning the inserted currency (i.e. similar to a vending machine currency return technology). The returned currency can be provided in a bin or area of machine 30, which can also be used for returning invalid inserted currency. The transaction fee can be in the form of a percentage of the amount of currency deposited. However, this type of fee is not considered limiting and other fees such as, but not limited to, a flat fee, a fiat fee that incrementally increases at certain thresholds, etc., can be used and all are considered within the scope of the invention. Though not preferred, it is also within the scope of the invention that no fee is charged for the service. For example an international bank could own machine 30 and offer the service for free to its customers (i.e. traveler/customer deposits the money in their bank account). Additionally, as machine 30 is in the United States, it is preferred, though not considered limiting, that the transaction fee be deducted from the amount of inserted United States currency, prior to the currency being converted into the selected country's currency, as discussed below. However, such is not considered limiting, and it is also within the scope of the present invention to deduct the fee after the United States currency has been converted.

The traveler inserts the United States currency into machine 30 through the currency receptacle(s). After the United States currency has been deposited, machine 30 tabulates the amount of currency in United States dollars and cents, which can be displayed on display or screen 40. Prior to displaying, machine 30 can include a navigation area or button for the user to inform machine 30 that all United States currency to be exchanged has been inserted. At this point the total amount can be displayed. Alternatively, a running total can be displayed as each type of United States currency is deposited into machine 30 through the currency receptacle(s).

The traveler selects the country of his or her choice (i.e. native country, country where the traveler has bank, account, etc.) for which the tabulated (totaled amount of deposit) will be converted and then transferred to. Machine 30 calculates the currency amount in the selected country's currency based on the Exchange Rate between the United States and the country selected. The total amount of the funds in the selected country's currency can be displayed, with or without the actual exchange rate information also listed.

Machine 30 displays several options for where the converted currency should he allocated. Though several options are preferred, it also within the scope of the invention that a single option is provided for the converted currency and this approach is also within the scope of the invention. A product, store, vendor, shopping mall, gift card can be provided as an option for allocating the converted currency. An airline gift card can be provided as an option for allocating the converted currency. A hotel gift card can be provided as an option for allocating the converted currency. A credit card, bank card, debit card, etc. can be provided as an option for allocating the converted currency. Other options can also be made available and are considered within the scope of the invention. The traveler selects one of the options provided. Though it is preferred that a single gift card is chosen, system 20 can be set up such that the traveler can be given the option of dividing the total amount of converted currency into two or more portions and selecting more than one option and designate the amount of the currency for each option. This alternative dividing option is also considered within the scope of the invention.

Where a gift card is selected, machine 30 dispenses the gift card, such as, but not limited to, through dispensing area 36. Where crediting a financial account is selected, the traveler slides his or her credit card, bank card, debit card, etc. into slot 38 where it is read by machine 30, through conventional card reading technology, and the designated amount of the converted currency (i.e. total amount, divided amount, etc.) is deposited or otherwise associated with the account associated with the card inserted into slot 38 and read by machine 30. Regardless of which card (i.e. gift, bank, debit, etc.) is selected, it is preferred (though not considered limiting) that a transaction receipt is printed and made available to the traveler. It should also be recognized that a voucher or voucher receipt can be provided by machine 30 to the user, for which the user redeems, turns in, deposits, mails in, etc. at another location nearby or remotely away from machine 30 to actually receive the converted currency, funds, etc. In all embodiments, machine 30 provides a quick, easy and convenient way for a user to obtain usable funds converted from unwanted foreign currency. As shown above, the usable funds can be provided to the user in many forms, and the forms shown and discussed above should not be considered limiting.

Additionally, the system can also be designed such that the vendor(s) displayed for choosing a gift card, can be associated and/or located in the country selected by the user. Therefore, the vendor(s) displayed may vary depending on the country selected by the user.

Similar to ATM machine technology, which is incorporated by reference, machine 30 can also be provided or designed to allow the user to accept which language he or she wishes to receive use instructions in. Additionally or alternatively, machine 30 can be designed such that when the user selects the country for which the currency is to be converted into usable funds, the machine automatically provides the use instructions in the native language of the country selected. Additionally, machine 30 can be provided with a safe or other secured or theft prevention box or receptacle for safely storing coins and paper money inserted into the machine.

Though the present invention has been discussed with respect to use by a traveler in a foreign country, the invention is not considered limited to use only by foreign travelers. Rather, any individual, regardless of whether or not the person is traveling, can be a user of the present invention.

For instance, in addition to converting foreign currency into a credit for a person's credit or debit card, the present invention system and method could be used by a non traveling person to increase their credit on a credit or debit card by inserting currency into system 20, sliding their card into the card reader of system 20 and indicating that no currency exchange conversion is necessary. On this same theme, system 20 could provide a self-use means for creating a gift card (i.e. such as a birthday present, anniversary present, etc.). In this non-limiting scenario, the non traveling person could insert their home country currency (preferably same country where machine 30 is located), again indicating that no currency exchange conversion is necessary, and also indicate that the deposited amount, (i.e. with or without a transaction fee) should be credited to the selected gift card. System 20 would then dispense the gift card (with or without a printed receipt) which can then be given as a present or however desired. Additionally, a vendor associated with the gift card can also place machine 30 into its store location to provide the customer with a self gift card generating device, without having to stand in line at the stores check out cashier or customer service areas. For this in store gift card generating use, it may not be necessary for machine 30 to contain all of the currency conversion technology. Other examples of use by a non-foreign traveler should become apparent and are also considered within the scope of the invention.

The system and/or machine of the present invention is preferably also provided to have the capability to reject invalid or incorrect currencies. As a non-limiting example, if the user is converting U.S. coins, if the user intentionally or inadvertently deposited a Canadian coin, a token, etc., the system and machine will reject the deposit and return the rejected coin or paper in slot, bin or area 61 of the machine. This technology can be similar to how a vending machine rejects invalid coin or paper insertions, which technology is incorporated by reference.

Accordingly, the present invention system and method provides a simple, convenient and quick outlet for travelers (or any other user) to transfer their left over or no longer needed currency by utilizing the present invention machine that can accept coins and currency and transfer such inserted coins and currency into usable funds of the user's choosing

While the invention has been described and disclosed in certain terms and has disclosed certain embodiments or modifications, person skilled in the art who have acquainted themselves with the invention, will appreciate that it is not necessarily limited by such terms, nor to the specific embodiments and modifications disclosed herein. Thus, a wide variety of alternatives, suggested by the teachings herein, can be practiced without departing from the spirit of the invention, and rights to such alternatives are particularly reserved and considered within the scope of the invention.

What is claimed is:

1. A system for converting foreign currency relative to a user's home country into a usable form of funds based on the user's home country currency, said system comprising:
means for receiving from a user currency of a foreign country relative to a user's home country; said means for receiving and said user located in the foreign country at the time the foreign country currency is received by said means for receiving;
means for receiving a current exchange rate between the foreign country currency and the user's home country currency; and
means for converting at least a portion of the received foreign country currency into a usable form of funds of the user's home country currency.

2. The system of claim 1 further comprising means for crediting a financial card or account with the amount of usable home country currency resulting from the conversion of said foreign country currency by said means for converting.

3. The system of claim 1 further comprising means for deducting a transaction fee from the received foreign country currency and said means for converting converts a remaining portion of said received foreign country currency.

4. The system of claim 3 wherein said financial card is gift card, credit card, gas card, debit card, store card, or voucher.

5. The system of claim 1 further comprising means for providing a receipt to the user of the currency conversion details.

6. The system of claim 1 wherein said means for receiving accepting both paper currency and coin currency of the foreign country.

7. The system of claim 1 wherein said means for receiving, said means for determining and said means for converting disposed within a housing and said housing disposed at an airport, hotel, bus station or train station

8. A system for converting foreign currency relative to a user's home country into a form of usable form of funds of the user's home country, said system comprising:
a housing having a display screen, one or more currency receiving apertures, a card receiving area and a receipt area, said member located in the a foreign country with relative a user's home country;
means for determining an amount of the foreign country currency inserted within said housing through said one or more currency receiving apertures, said means for determining disposed within said housing and in communication with the one or more currency receiving apertures, wherein the determined amount of the inserted foreign country currency is viewable to the user on the display screen;
means for deducting a transaction fee from the received foreign country currency;
means for selecting the user's home country currency for the country currency to convert the foreign country currency into;
means for receiving a current exchange rate between the foreign country currency and the user's home country currency,
means for converting the received foreign country currency less the deducted transaction fee into a usable form of funds of the user's home country currency; and
means for providing a receipt to the user of the currency conversion details;
wherein said means for deducting, said means for receiving, said means for converting and said means for providing disposed within said housing.

9. The system of claim 8 further comprising means for crediting a financial card or account with the amount of usable home country currency resulting from the conversion of said foreign country currency by said means for converting.

10. The system of claim 9 wherein said financial card is gift card, credit card, gas card, debit card, store card or voucher.

11. The system of claim 9 wherein said housing having a first area for insertion of paper currency and a second area for insertion of coin currency.

12. A method for converting foreign currency relative to a user's home country into a usable form of funds based on the user's home country currency, said method comprising the steps of;
(a) receiving from a user currency of a foreign country relative to a user's home country; said user is located in the foreign country at the time the foreign country currency is received from the user;
(b) receiving a current exchange rate between the foreign country currency and the user's home country currency;
(c) converting at least a portion of the received foreign country currency into a usable form of funds of the user's home country currency; and
(d) crediting a financial account designated by the user in the amount converted into the user's home country currency.

13. The method of claim 12 wherein step (d) comprises the step of crediting a designated bank account, debit card, credit card account, gift card or voucher with the amount converted into the user's home country currency.

14. The method of claim 12 further comprising the step of deducting a portion of the receiving foreign country currency as a transaction fee prior to crediting the financial account.

15. The method of claim 12 further comprising the step of deducting a portion of the converted home country currency as a transaction fee prior to crediting the financial account.

16. The method of claim 12 further comprising the step of providing the user with a receipt of the currency conversion details.

17. The method of claim 12 where step (a) includes receiving either paper currency or coin currency of the foreign country or both paper currency and coin currency of the foreign country.

18. The method of claim 12 further comprising the step of selecting a country for the user's home country prior to receiving the currency exchange range of step (b).

19. A method for converting foreign currency relative to a user's home country into a usable form of funds based on the user's home country currency, said method comprising the steps of:
(a) providing a housing at a common final destination of a foreign country when traveling in the foreign country relative to a user's home country, said housing containing a central computer and data storage for tabulating received currency, receiving accurate currency exchange rates, converting received currency into a currency amount of another country and crediting a financial account selected by a user;
(b) inserting into the housing by the user currency of the foreign country;
(c) calculating a total amount of foreign country currency inserted at step (a);
(d) selecting a home country for the user;
(e) receiving a current exchange rate between the foreign country currency and the user's selected home country currency;
(f) converting at least a portion of the inserted foreign country currency into a usable form of funds of the user's home country currency; and
(g) crediting a financial account designated by the user in the amount converted into the user's home country currency.

20. The method of claim 19 wherein step (f) comprises the step of crediting a designated bank account, debit card, credit card account, gift card or voucher with the amounted converted into the user's home country currency.

21. The method of claim 19 further comprising the step of deducting a portion of the inserted foreign country currency as a transaction fee prior to crediting the financial account.

22. The method of claim 19 further comprising the step of deducting a portion of the converted home country currency as a transaction fee prior to crediting the financial account.

23. The method of claim 19 further comprising the step of providing the user with a receipt of the currency conversion details.

24. The method of claim 19 where step (b) includes inserting either paper currency or coin currency of the foreign country or both paper currency and coin currency of the foreign country.

25. A method for converting foreign currency relative to a user's home country into a usable form of funds based on the user's home country currency, said method comprising the steps of:
(a) providing a housing at a common final destination of a foreign country when traveling in the foreign country relative to a user's home country, said housing containing a central computer and data storage for tabulating received currency, receiving accurate currency exchange rates, converting received currency into a currency amount of another country and crediting a financial account selected by a user;
(b) inserting into the housing by the user currency of the foreign country which can be either paper currency or coin currency of the foreign country or both paper currency and coin currency of the foreign country;
(c) calculating a total amount of foreign country currency inserted at step (a);
(d) deducting a portion of the inserted foreign country currency as a transaction fee;
(e) selecting a home country for the user;
(f) receiving a current exchange rate between the foreign country currency and the user's selected home country currency;
(g) converting the inserted foreign country currency less the deducted transaction fee into a usable form of funds of the user's home country currency;
(h) selecting a financial account for crediting the amount of converted home country currency from a group consisting of credit card account(s), bank account(s), debit cards and gift cards;
(i) crediting the selected financial account in the amount converted into the user's home country currency; and
(j) providing the user with a printed receipt of the currency conversion details.
